(19) United States
(12) Patent Application Publication
(10) Pub. No.: US 2010/0283627 A1
(43) Pub. Date: Nov. 11, 2010

(54) CEILING-MOUNTED HOOKING RECEPTACLE

(76) Inventor: Satoru Ueno, Osaka-shi (JP)

Correspondence Address: Cheng Law Group, PLLC, 1100 17th Street, N.W., Suite 503, Washington, DC, 20036, US

(21) Appl. No.: 12/810,165

(22) PCT Filed: Dec. 25, 2008
(86) PCT No.: PCT/JP2008/073622

§ 371 Date: Jul. 7, 2010

(30) Foreign Application Priority Data
Dec. 26, 2007 (JP) 2007-335176

(51) Int. Cl. H02J 13/00; H02J 1/00

(52) U.S. Cl. 340/825.52; 307/112

(57) ABSTRACT

The ceiling-mounted hooking receptacle (1) includes a terminal unit (2a) adapted in use to be connected to a DC supply line (Wdc) from an installation site side, a terminal unit (2b) used for a power transmission wiring, and a hooking connection unit (3) adapted in use to detachably be connected to a hooking cap of a DC device (102). In addition, the ceiling-mounted hooking receptacle (1) includes a DLC communication unit (5) and a power supply control unit (6). The hooking connection unit (3) includes hooking blade reception members (22) configured to hook the hooking blades (41) provided to the hooking cap. A switch (4) is provided to power supply lines connecting the hooking connection unit (3) to the terminal units (2a) and (2b). The DLC communication unit (5) is configured to establish a DLC communication with an external device either by superimposing a high frequency transmission signal on DC voltage applied to the terminal unit (2a) and (2b) or separating the superimposed transmission signal from the DC voltage applied to the terminal unit (2a) and (2b). The power supply unit (6) is configured to turn on and off the switch (4) on the basis of a control signal included in the transmission signal received from the external device.

### TECHNICAL FIELD

The present invention is directed to a ceiling-mounted hooking receptacle.

### BACKGROUND ART

Japanese Non-examined Patent Publication No. 2001-35585 discloses a ceiling-mounted hooking receptacle. The ceiling-mounted hooking receptacle is mounted on an installation site such as a ceiling surface. The ceiling-mounted hooking receptacle is adapted in use to be detachably connected to a hooking cap of a lighting fixture. The ceiling-mounted hooking receptacle supplies AC power to the lighting fixture via the hooking cap.

The ceiling-mounted hooking receptacle includes a housing mounted on an installation site. The housing is formed in its room side surface with a plurality of hooking blade insertion slots having an arc shape. The housing houses a plurality of terminals. Each of the terminals is adapted in use to be connected to a feeder wire inserted into the housing from an installation site side of the housing. Further, the housing houses a plurality of hooking blade reception members. The plurality of the hooking blade reception members is housed in the housing so as to respectively correspond to the plurality of the hooking blade insertion slots. The plurality of the hooking blade reception members is respectively electrically connected to the plurality of the terminals. The aforementioned hooking blade reception members is configured to hook the hooking blade when a hooking blade of a hooking cap has been inserted into the housing via a first end portion of the hooking blade insertion slot and subsequently has been moved to a second end portion of the hooking blade insertion slot.

The aforementioned ceiling-mounted hooking receptacle only supplies AC power to the connected lighting fixture. Therefore, in order to control an operation of the lighting fixture connected to the ceiling-mounted hooking receptacle from a remote location, use of a dedicated lighting fixture is required. The dedicated lighting fixture is a lighting fixture having a function of communicating with a remotely-positioned control device. Moreover, the dedicated lighting fixture is required to be connected to a control wire in addition to a feeder wire. The control wire is a wire used for transmitting a control signal controlling the operation of the dedicated lighting fixture.

As described in the above, in order to control the operation of the lighting fixture connected to the ceiling-mounted hooking receptacle, the control line need be wired in addition to the power line (see Japanese Non-examined Patent Publication No. 7-54751). This complicates wiring. In addition, use of the dedicated lighting fixture having a communication function communicating with the control device as well as a control function is required. Further, a control system need be constructed by connecting the feeder wire and control wire to a lighting fixture. Therefore, a user can not select and replace a device to be controlled.

### DISCLOSURE OF INVENTION In view of above insufficiency, the present invention has been aimed to provide a ceiling-mounted hooking receptacle which is capable of freely making selection or replacement of a DC device to be controlled.

The ceiling-mounted hooking receptacle in accordance with the present invention includes a housing adapted in use to be mounted on an installation site. The housing is formed with a plurality of hooking blade insertion slots having an arc shape in its surface different from its installation site side surface. The housing houses a plurality of terminals, and each of the terminals is adapted in use to be connected to a feeder wire of a DC power source inserted into the housing from the installation site side of the housing. Further, the housing houses a plurality of hooking blade reception members respectively electrically connected to the plurality of the terminals. The plurality of hooking blade reception members is housed in the housing so as to respectively correspond to the plurality of the hooking blade insertion slots. The hooking blade reception members is configured to hook the hooking blade when a hooking blade of a hooking cap has been inserted into the housing via a first end portion of the hooking blade insertion slot and subsequently has been moved to a second end portion of the hooking blade insertion slot. In addition, the ceiling-mounted hooking receptacle includes a contact provided to a power supply line between the plurality of the terminals and the plurality of the hooking blade reception members. The housing is configured to house a communication unit and a power supply control unit. The communication unit is configured to communicate with an external device by use of a transmission signal superimposed on DC voltage applied to the terminal. The power supply control unit is configured to turn on or off the contact on the basis of a control signal included in the transmission signal received by the communication unit.

According to the present invention, in accordance with the control signal included in the received transmission signal, the power supply control unit is enabled to make or terminate a power being supplied to the hooking blade reception member. Thus, it is possible to make and terminate the supplying power to the DC device by use of the control signal. Therefore, it is sufficient that the terminal of the ceiling-mounted hooking receptacle is connected to only the feeder wire of the DC power source. The ceiling-mounted hooking receptacle need not be connected to a line used for transmitting the transmission signal which is different from the feeder wire. Therefore, it is possible to assure a simplified wiring and installation (less wiring requirement to the ceiling-mounted hooking receptacle and easy installation). Moreover, in order to control the DC switch, there is no need to preliminary construct a control system with the use of a feeder wire and a control wire for connection of the ceiling-mounted hooking receptacle to a switch. Therefore, it is possible to freely make selection or replacement the DC device such as a lighting fixture desired to be remote-controlled.

In a preferred embodiment, the ceiling-mounted hooking receptacle includes an address registration unit configured to register a unique address. The power supply control unit is configured to, when a unique address included in the transmission signal received by the communication unit is identical to the unique address registered by the address registration unit, turn on and off the contact on the basis of the control signal included in the received transmission signal.

According to this embodiment, even if the plural ceiling-mounted hooking receptacles are connected to the feeder wire of the DC power source, it is possible to indentify each of the ceiling-mounted hooking receptacles by use of the unique address registered by the address registration unit. Therefore, it is possible to make and terminate supplying power to electric devices connected respectively to the ceiling-mounted hooking receptacles.

In a more preferable embodiment, the address registration unit includes an address reception unit configured to receive a unique address transmitted in the form of a wireless signal by an external address registration device and an address storage unit configured to store the unique address received by the address reception unit as the unique address.

According to this embodiment, when the address reception unit receives the unique address transmitted in the form of the wireless signal from the external address registration device, the address storage unit stores the received address. Therefore, it is possible to make a unique address registration by use of the address registration device from a remote location.

### BRIEF DESCRIPTION OF DRAWINGS

FIG. 1A is a schematic system configuration view illustrating a control system including a ceiling-mounted hooking receptacle of a first embodiment,

FIG. 1B is a schematic block diagram illustrating the above ceiling-mounted hooking receptacle and a DC switch,

FIG. 2 is an exploded perspective view illustrating the above exposed-type ceiling-mounted hooking receptacle of one embodiment,

FIG. 3 is a perspective view illustrating the above ceiling-mounted hooking receptacle of an exposed-type,

FIG. 4 is a perspective view illustrating the above ceiling-mounted hooking receptacle of an embedded-type,

FIG. 5A is a schematic system configuration view illustrating a control system including a ceiling-mounted hooking receptacle of a second embodiment,

FIG. 5B is a schematic block diagram illustrating the above ceiling-mounted hooking receptacle and a DC switch,

FIG. 6A is a perspective view illustrating the above ceiling-mounted hooking receptacle of an exposed-type,

FIG. 6B is a perspective view illustrating the above ceiling-mounted hooking receptacle of an embedded-type,

FIG. 6C is an explanatory view illustrating an address registration unit of the above ceiling-mounted hooking receptacle,

FIG. 7 is a schematic block diagram illustrating a ceiling-mounted hooking receptacle of a third embodiment and an address registration device,

FIG. 8 is an explanatory view illustrating an operation of address registration,

FIG. 9A is an external view illustrating the address registration device used for the aforementioned address registration,

FIG. 9B is a diagram illustrating a registration screen of the address registration device,

FIG. 10 is a perspective view illustrating the above ceiling-mounted hooking receptacle of an embedded-type, and

FIG. 11 is a system configuration view illustrating a DC distribution system including the ceiling-mounted hooking receptacle of the embodiments.

### BEST MODE FOR CARRYING OUT THE INVENTION

### First Embodiment

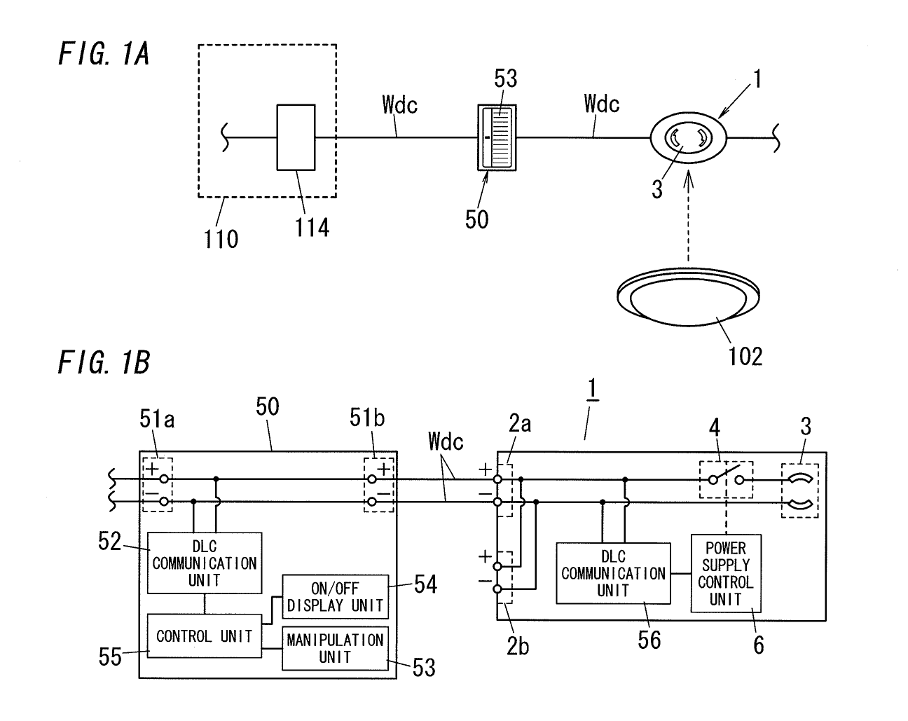

An explanation is made to the first embodiment of the present invention with reference to FIGS. 1 to 4. The ceiling-mounted hooking receptacle 1 is mounted on a ceiling as an installation site. This ceiling-mounted hooking receptacle 1 is adapted in use to be connected to a hooking cap 40 of a DC device 102 activated by DC power. The ceiling-mounted hooking receptacle 1 supplies DC power to the DC device via the hooking cap 40. It is noted that the hooking cap 40 includes hooking blades 41 having an L-shape.

FIG. 1A is a schematic system configuration view illustrating a primary part of a control system utilizing the ceiling-mounted hooking receptacle 1 of the present embodiment. FIG. 1A shows a distribution panel 110 located in a residence and a DC breaker 114 incorporated in the distribution panel 110. In the illustrated instance, the ceiling-mounted hooking receptacle 1 is connected to a DC supply line Wdc branched off from the DC breaker 114. Further, a DC switch 50 is provided to the DC supply line Wdc between the ceiling-mounted hooking receptacle 1 and the DC breaker 114. The DC switch 50 is used for turning on and off the DC device 102 such as a lighting fixture connected to the ceiling-mounted hooking receptacle 1.

As shown in FIG. 1B, the ceiling-mounted hooking receptacle 1 includes a terminal unit 2a adapted in use to be connected to a DC supply line (feeder wire of a DC power source) Wdc from the installation site side, and a terminal unit 2b used for a power transmission wiring. The ceiling-mounted hooking receptacle 1 includes a hooking connection unit 3, a switch 4, a DLC communication unit 5, and a power supply control unit 6. The hooking connection unit 3 is adapted in use to be detachably connected to the hooking cap 40 of the DC device 102. The aforementioned hooking connection unit 3 includes hooking blade reception members 22 configured to hook the hooking blades 41 provided to the hooking cap 40. The switch 4 is provided with power supply lines connecting the hooking connection unit 3 to the terminal units 2a and 2b. The aforementioned switch 4 can be selected from a relay contact, a semiconductor switch, and the like, for example. The DLC communication unit 5 is configured to establish a DLC communication with an external device either by superimposing a high frequency transmission signal on DC voltage applied to the terminal unit 2a and 2b, or separating the superimposed transmission signal from the DC voltage applied to the terminal unit 2a and 2b. The power supply unit 6 is configured to turn on and off the switch 4 on the basis of a control signal included in the transmission signal received from the external device.

In the present embodiment, each of the terminal units 2a and 2b includes two terminals (positive terminal and negative terminal). The hooking connection unit 3 includes the two hooking blade reception members 22 (positive hooking blade reception member and negative hooking blade reception member). In the present embodiment, the switch 4 is provided to only the power supply line which connects the positive hooking blade reception member 22 of the hooking connection unit 3 to the positive terminals of each of the terminal units 2a and 2b. However, the switch 4 may be provided to the power supply line which connects the negative hooking blade reception member 22 of the hooking connection unit 3 to the negative terminals of each of the terminal units 2a and 2b. Further, each of the terminal units 2a and 2b may include the two or more terminals, and the hooking connection unit 3 may include the two or more hooking blade reception members 22. In this case, the switch 4 may be provided to at least one of or all of the power supply lines connecting the plurality of the hooking blade reception members 22 of the hooking connection unit 3 respectively to the plurality of the terminals of the terminal units 2a and 2b.

The DC switch 50 is installed on a building surface such as a wall surface. As shown in FIG. 1B, the DC switch 50 includes a terminal unit 51a adapted in use to be connected to the DC supply line Wdc, and a terminal unit 52b used for a power transmission wiring. The DC switch 50 further includes a DLC communication unit 52, a manipulation unit 53, an on/off display unit 54, and a control unit 55. The DLC communication unit 52 is configured to establish a DLC communication with an external device either by superimposing a high frequency transmission signal on DC voltage applied to the terminal unit 51a and 51b, or separating the superimposed transmission signal from the DC voltage applied to the terminal unit 51a and 51b. The manipulation unit 53 serves to turn on and off the corresponding DC device 102. The on/off display unit 54 includes a light emitting diode (not shown). The on/off display unit 54 is configured to control a lighting state of the light emitting diode no as to display an on-state and off-state of the corresponding DC device 102. The light emitting diode is provided such that a user can see the lighting state of the light emitting diode from a front surface of the DC switch 50. The control unit 55 is configured to control each of units.

Next, an explanation is made to an on/off operation where the DC switch 50 turns on and off the DC device 102. In a condition where the lighting DC device 102 is kept turned off, the control unit 55 of the DC switch 50 keeps on turning on the light emitting diode of the on/off display unit 54 in accordance with a monitoring signal received from the corresponding ceiling-mounted hooking receptacle 1 (which is a control target of the DC switch 50), thereby displaying the off-state of the DC device 102 and a location of the DC switch 50. In this condition, the manipulation unit 53 outputs an on-operation signal to the control unit 55 when the manipulation unit 53 of the DC switch 50 is manipulated to turn on the DC device 102. Upon receiving the on-operation signal, the control unit 55 controls the DLC communication unit 56 to send to the corresponding ceiling-mounted hooking receptacle 1 the transmission signal including the control signal for turning on the DC switch 102. In the ceiling-mounted hooking receptacle 1 which is preliminarily associated with the DC switch 50, the DLC communication unit 5 receives the control signal included in the transmission signal. The power supply control unit 6 turns on the switch 4 in accordance with the received control signal. Thereby, the ceiling-mounted hooking receptacle 1 supplies DC power to the DC device 102, and the lighting DC device 102 is turned on. Further, at the same time that the power supply control unit 6 turns on the switch 4, the power supply control unit 6 controls the DLC communication unit 5 to send to the corresponding DC switch 50 the monitoring signal indicative of the switch 4 being turned on When the DLC communication unit 52 of the DC switch 50 receives the transmission signal from the corresponding ceiling-mounted hooking receptacle 1, the control unit 55 controls the on/off display unit 54 in accordance with the monitoring signal included in the received transmission signal. In this case, since the monitoring signal indicates that the switch 4 is turned on, the control unit 55 turns off the light emitting diode of the on/off display unit 54. In short, the off-state of the light emitting diode of the on/off display unit 54 indicates that the DC switch 102 is kept turned on.

Meanwhile, in a condition where the lighting DC device 102 is kept turned on, the manipulation unit 53 outputs an off-operation signal to the control unit 55 when the manipulation unit 53 of the DC switch 5 is manipulated to turn off the DC device 102. Upon receiving the off-operation signal, the control unit 55 sends to the corresponding ceiling-mounted hooking receptacle 1 the transmission signal including the control signal for turning off the DC switch 102. In the ceiling-mounted hooking receptacle 1 which is preliminarily associated with the DC switch 50, the DLC communication unit 5 receives the control signal included in the transmission signal. The power supply control unit 6 turns off the switch 4 in accordance with the received control signal. Thereby, the ceiling-mounted hooking receptacle 1 cuts off the electrical power supplied to the DC device 102, and the lighting DC device 102 is turned off. Further, at the same time that the power supply control unit 6 turns off the switch 4, the power supply control unit 6 controls the DLC communication unit 5 to send to the corresponding DC switch 50 the monitoring signal indicative of the switch 4 being turned off When the DLC communication unit 52 of the DC switch 50 receives the transmission signal from the corresponding ceiling-mounted hooking receptacle 1, the control unit 55 controls the on/off display unit 54 in accordance with the monitoring signal included in the received transmission signal. In this case, since the monitoring signal indicates that the switch 4 is turned off, the control unit 55 turns on the light emitting diode of the on/off display unit 54. In short, the on-state of the light emitting diode of the on/off display unit 54 indicates that the DC switch 102 is kept turned on.

As explained in the above, in the ceiling-mounted hooking receptacle 1, when an external device sends the transmission signal by means of superimposing the transmission signal on the DC voltage applied to the DC supply line Wdc of the installation site side, the DLC communication unit 5 receives the transmission signal superimposed on the DC voltage. In accordance with the control signal included in the received transmission signal, the power supply control unit 6 makes and terminate supplying power to the hooking blade reception members 22. Thus, it is possible to make and terminate the supplying power to the DC device 102 connected to the hooking connection unit 3 by use of the control signal included in the transmission signal superimposed on the DC voltage. Moreover, in the present embodiment, it is sufficient that the each of the terminal units 2a and 2b of the ceiling-mounted hooking receptacle 1 is connected to only the DC supply line Wdc. The ceiling-mounted hooking receptacle 1 need not be connected to a line used for transmitting the transmission signal which is different from the DC supply line Wdc. Therefore, it is possible to achieve a simplified wiring and installation (less wiring requirement to the ceiling-mounted hooking receptacle 1 and easy installation thereof). Moreover, while the DC device 102 is connected to the ceiling-mounted hooking receptacle 1 of the present embodiment, the ceiling-mounted hooking receptacle 1 can make and terminate supplying power to the DC device 102 for controlling to turn on and off the DC device 102. Accordingly, the DC device 102 to be controlled is not limited to a dedicated DC device having a communication function and the like. Therefore, it is possible to freely make selection or replacement of the DC device 102 to be controlled.

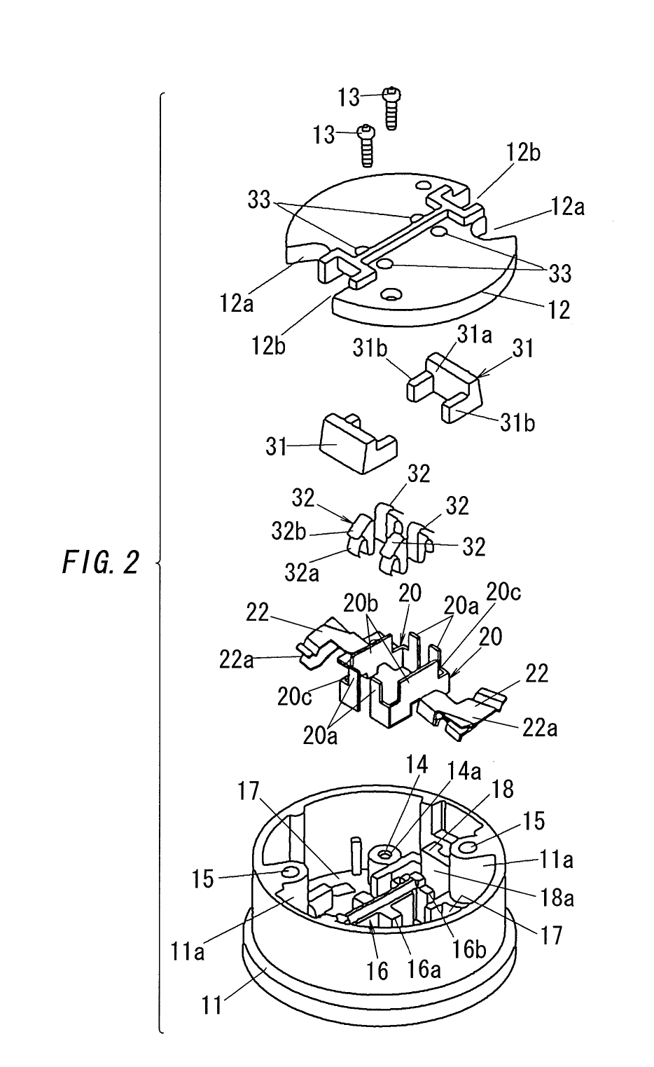

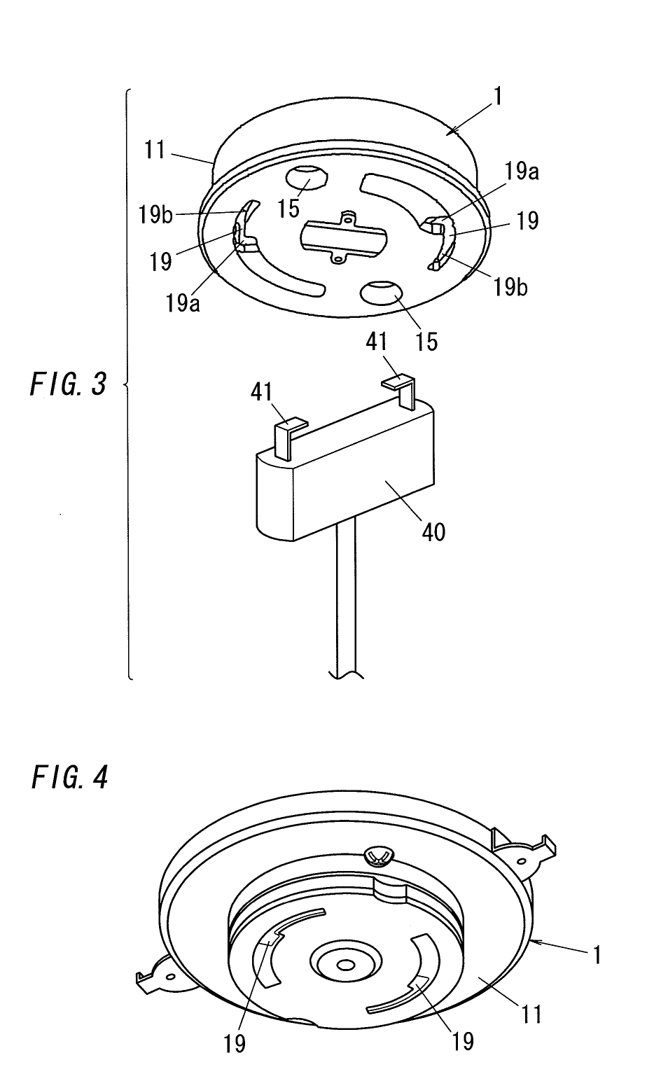

Now, as shown in FIGS. 2 and 3, the ceiling-mounted hooking receptacle 1 of the present embodiment includes a housing 11 and a terminal cover 12. In order to simplify an explanation, it is assumed that an upward/downward direction in FIG. 2 denotes an upward/downward direction of the ceiling-mounted hooking receptacle 1 in the following explanation,

The housing 11 is shaped into a cylindrical shape. The housing 11 has its entire upper surface opened and its lower surface closed. The housing 11 is mounted on the ceiling surface (the housing 11 is attached to the ceiling surface) with contacting the ceiling surface to its upper surface. The terminal cover 12 is shaped into a circular plate shape. The terminal cover 12 is inserted into the housing 11 from the upper surface side of the housing 11. Each of the housing 11 and terminal cover 12 is a molded product made of thermoset resins (e.g. melamine-phenol resins and polyester resins). Use of melamine-phenol resins or polyester resins can give fire retardancy to the housing 11 and terminal cover 12.

The terminal cover 12 is coupled to the housing 11 by use of assembly screws 13 being a tapping screw. The terminal cover 12 is formed with two notches 12a at different positions of its outer periphery. By contrast, the housing 11 is formed with two cylindrical portions 11a at different positions of its inner periphery. To fit respectively the cylindrical portions 11a into the notches 12a positions the terminal cover 12 in relation to the housing 11.

The housing 11 is formed with a pair of supporting walls 14 on its interior bottom surface. In a case of coupling the housing 11 to the terminal cover 12, the terminal cover 12 is placed over the support walls 14. In this condition, the each assembly screw 13 is screwed into a hole 14a of the support wall via the terminal cover 12. Thereby, the terminal cover 12 is coupled to the housing 11. Dimensions of each of the housing 11, terminal cover 12, and support walls 14 are selected such that the terminal cover 12 has its upper surface positioned higher than the upper surface of the housing 11 when the terminal cover 12 is placed over the support walls 14.

The housing 11 is formed with the two cylindrical portions 11a at the different positions of its inner periphery. Each of the cylindrical portions 11a is formed with an insertion holes 15 penetrating through the housing 11 in the upward/rearward direction of the housing 11. The housing 11 is secured to the ceiling surface by respectively screwing two fixing screws (not shown) into the ceiling surface via the two insertion holes 15 from the lower surface side of the housing 11.

The housing 11 is formed on its interior bottom surface with a partition wall 16 which divides the inside space of the housing 11 into two storage rooms 17. The partition wall 16 is formed with a bearing piece 16a projecting from a longitudinal center of the partition wall 16 in opposite width directions thereof. In addition, the partition wall 16 is formed with support ribs 16b projecting from opposite longitudinal ends of the partition wall 16 in the opposite width directions thereof. Further, the housing 11 is formed on its interior bottom surface with pedestals 18 disposed opposite of the partition wall 16 from the corresponding support rib 16b.

Two hooking blade insertion slot 19 are respectively formed in a periphery of the bottom of the housing 11 corresponding to the two storage rooms 17. The hooking insertion slot 19 is shaped into an approximately arc shape. The hooking insertion slot 19 is used for inserting the hooking blade 41 of the hooking cap 40 into the housing 11. The hooking insertion slots 19 are disposed on a circumference centered at the center of the bottom of the housing 11. Each of the hooking blade insertion slots 19 has a wide portion 19a in a first end to which the hooking blade 40 comes when the hooking cap 40 has been rotated counterclockwise in FIG. 3. The wide portion 19a is greater in width than the other portion of the hooking blade insertion slot 19. The wide portion 19a extends toward the center of the bottom of the housing 11 relative to a narrow portion 19b being the other portion. Thereby, the width of the hooking blade insertion slot 19 is expanded at the wide portion 19a.

In an operation where the hooking blade 41 is inserted into the hooking blade insertion slot 19, first the hooking blade 41 is inserted into the wide portion 19a. Thereafter, the hooking cap 40 is rotated clockwise in FIG. 3. Thereby, an end of the hooking blade 41 overlaps a periphery of the narrow portion 19b. The hooking blade reception member 22 is disposed on a vicinity of the narrow portion 19b of the hooking blade insertion slot 19. In the ceiling-mounted hooking receptacle 1 shown in FIGS. 2 and 3, the hooking blade insertion slots 19 and hooking blade reception members 22 constitute the aforementioned hooking blade connection unit 3.

It is noted that the hooking blade insertion slot 19 is different in a shape and dimensions from that of the ceiling-mounted hooking receptacle used for connecting to an AC power source. One of the hooking blade insertion slots 19 is a positive hooking blade insertion slot used for connecting to a positive electrode, and another of the hooking blade insertion slots 19 is a negative hooking blade insertion slot used for connecting to a negative electrode. Preferably, the positive hooking blade insertion slot 19 and the negative hooking blade insertion slots 19 are asymmetrically shaped with respect to the center of the bottom of the housing 11, in order to prevent the hooking blades 41 from being inserted into the hooking blade insertion slots 19 at improper polarity. It is also preferred that the hooking blades 41 respectively for connection with the positive and negative electrodes are asymmetrically shaped in match with the shape of the hooking blade insertion slot 19.

The hooking blade reception member 22 is made of a sheet-metal. The hooking blade reception member 22 each includes a blade reception spring 22a configured to nip the end of the hooking blade 41. The hooking blade reception member 22 is housed in the housing 11 such that the blade reception spring 22a is located along the hooking blade insertion slot 19. The blade reception spring 22a has its apex, which is exposed to the wide portion 19a of the hooking blade insertion slot 19, and is shaped to have an upslope inclination in its upper surface. Accordingly, the hooking blade 41 can easily be placed over the blade reception spring 22a. Therefore, when the end of the hooking blade 41 is inserted into the narrow portion 19b, the end of the hooking blade 41 is placed over the upslope inclination of the blade reception spring 22a. As a result, the blade reception spring 22a hooks and holds the hooking blade 41. It is noted that there is a gap between the bottom of the housing 11 and a portion extended from the apex of the blade reception spring 22a of the hooking blade reception member 22. While the blade reception spring 22a and the bottom of the housing 11 are interposed between the end of the hooking blade 41 and a body of the hooking cap 40, the end of the hooking blade 41 resiliently contacts to the blade reception spring 22a against an upward bias of the blade reception spring 22a.

A terminal clasp 20 is housed in each of the two storage rooms 17 of the housing 11. The terminal clasp 20 is used for connecting the feeder wire of the DC power source. The terminal clasp 20 includes terminal plates 20a in a pair and a connection piece 20b, and is shaped into a U-shape. Each of the terminal plates 20a has contact with the corresponding support rib 16b. The connection piece 20b links ends of each of the terminal plates 20a. The terminal clasp 20 is made of a sheet-metal. The aforementioned terminal clasp 20 is housed in the housing 11 as being upstanding from the interior bottom surface of the housing 11. In each of the storage rooms 17, a lock spring 32 is interposed between the bearing piece 16a and the terminal plate 20a. The lock spring 32 includes a contact portion 32a formed by bending a first end portion of a band plate into an S-shape and a lock portion 32b formed by bending a second end portion of the band plate into a J-shape. The lock spring 32 is placed such that the contact piece 32a and the lock piece 32b are opposed to the terminal plate 20a. Further, the lock spring 32 is placed to have the lock piece 32b oriented upwardly and the contact piece 32a oriented downwardly.

In order to connect a power wire (e.g. the feeder wire of the DC power source) to the terminal unit 2a, a user is required to insert the power wire into the housing 11 via a wire insertion hole 33 provided to the terminal cover 12. According to this, the power wire is held between the terminal plate 20a and the contact piece 32a and lock piece 32b. In this case, the contact piece 32a has contact with a conductor of the power wire. Thereby, the power wire is successfully electrically connected to the terminal unit 2a. Further, an apex edge of the lock piece 32b sticks into the conductor of the power wire. Thereby, the terminal unit 2a holds the power wire such that the power wire is not easily uncoupled from the terminal unit 2a. In the instance shown in FIGS. 2 and 3, the terminal units 2a and 2b includes a terminal having a so-called screwless terminal construction by use of the terminal clasp 20 and the lock spring 32.

Release buttons 31 are disposed in the housing 11. The release button 31 is used for detaching the power wire held by the terminal plate 20a and the lock spring 32. The release button 31 includes an operation portion 31a and pressing pieces 31b provided to opposite ends of the operation portion 31a. In short, the release button 31 is shaped into a shape where the pressing pieces 31b in a pair are integrally linked by the operation portion 31a. The operation portion 31a is placed over the center portion 18a of the pedestal 18. The terminal cover 12 is provided with operation openings 12b each of which is a notch for exposing the corresponding operation portion 31a. The pressing pieces 31b is respectively located in opposite ends of the partition wall 16. Each of the pressing pieces 31b has its apex end contacting to the lock pieces 32b of the lock springs 32. The pressing piece 31b is disposed in the housing 11 so as to move via an insertion notch 20c provided to the terminal clasp 20.

In order to uncouple the power wire from the terminal unit 2a or 2b, a user is required to insert an apex of a jig (e.g. a flat-blade screwdriver) into the operation opening 12b and subsequently presses the operation portion 31a toward the center side of the housing 11 by use of the inserted apex of the jig. Thereby, the pressing pieces 31b in a pair respectively deform the lock pieces 32b in a pair such that each lock piece 32b moves away from the corresponding terminal plate 20a. As a result, the lock piece 32b is detached from the power wire, Therefore, it is possible to pull out the power wire. The release button 31 overlaps both of the terminal clasps 20. Accordingly, one release button 31 can deform the lock pieces 32b of the two lock springs 32 having the different polarity. In short, one release button 31 can uncouple the two power wires from the terminal unit 2a or 2b at the same time. Therefore, the ceiling-mounted hooking receptacle 1 has good handleability.

Moreover, a printed wiring board (not shown) is housed in the housing 11 so as to extend from one of the storage rooms 17 to another of the storage rooms 17. The printed wiring board includes the switch 4 shown in FIG. 4, and electrical circuits of the DLC communication unit 5, power supply unit 6, and the like. Further, the terminal clasps 20 and hooking blade reception members 22 are soldered to the printed wiring board.

In order to mount the aforementioned ceiling-mounted hooking receptacle 1 of the present embodiment on the ceiling surface, a user is required to screw the fixing screws (not shown) into the ceiling surface via the insertion holes 15 while the upper surface of the housing 11 is contacted to the ceiling surface. As described in the above, it is possible to easily mount the ceiling-mounted hooking receptacle 1 on the installation site because the user is only required to make through holes for passing through the power wires in the ceiling surface.

By the way, the ceiling-mounted hooking receptacle 1 shown in FIGS. 2 and 3 is a ceiling-mounted hooking receptacle of an exposed type mounted on the installation site in a condition where the upper surface of the housing 11 is contacted to the ceiling surface. However, the technical idea of the present invention can be applied to a ceiling-mounted hooking receptacle of an embedded type shown in FIG. 4. The ceiling-mounted hooking receptacle shown in FIG. 4 is mounted on the installation site in a condition where the upper portion of the housing 11 is inserted in an embedded hole (not shown) provided to the ceiling surface.

### Second Embodiment

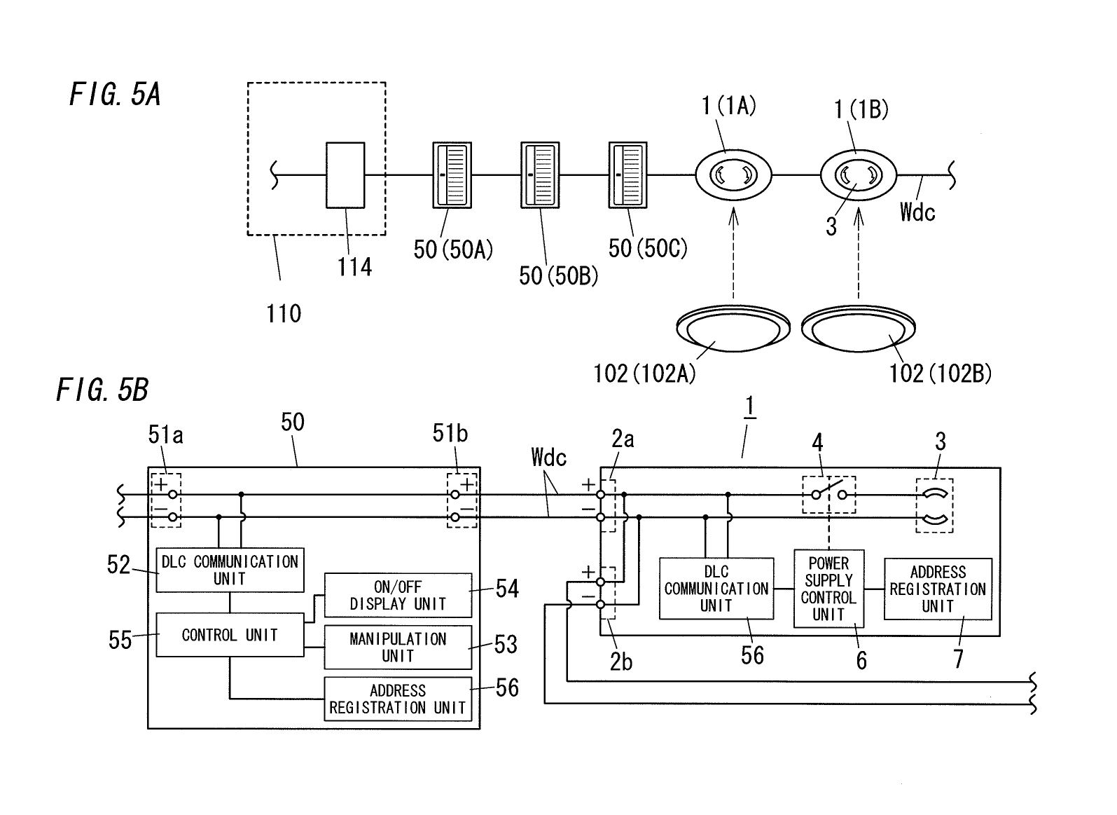

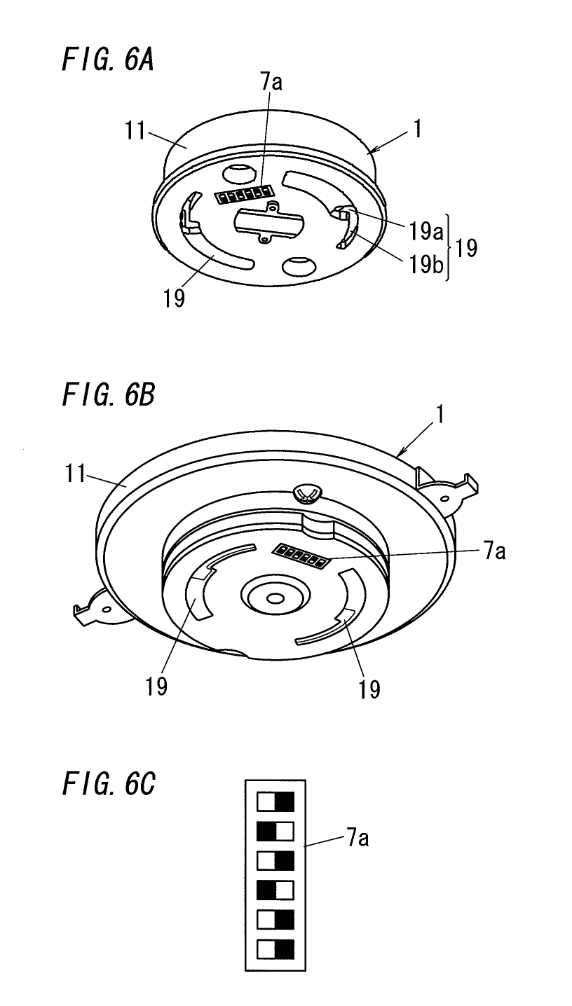

With reference to FIGS. 5 and 6, an explanation is made to the second embodiment of the present invention. In the present embodiment, a unique address is assigned to each of the ceiling-mounted hooking receptacle 1 and the DC switch 50 explained in the first embodiment. In the present embodiment, in response to the manual operation of the DC switch 50, the DC device 102 connected to the ceiling-mounted hooking receptacle 1 having the corresponding unique address is turned on and off. It is noted that components common to the present embodiment and the first embodiment are designated by like reference numerals and dispensed with duplicate explanations.

FIG. 5A shows a schematic system configuration diagram of a control system employing the ceiling-mounted hooking receptacle 1 of the present embodiment. The DC supply line Wdc branched from the DC breaker 114 is connected to the two ceiling-mounted hooking receptacles 1 and the three DC switches 50. Further, each of the two ceiling-mounted hooking receptacles 1 is connected to the different lighting DC devices 102. In a following explanation, the reference numbers 1A and 1B are used in order to distinguish the two ceiling-mounted hooking receptacles 1, as necessary. Moreover, the reference numbers 50A, 50B, and 50C are used in order to distinguish the three DC switches 50, as necessary. Further, the reference numbers 102A and 102B are used in order to distinguish the two DC devices 102, as necessary.

As shown in FIG. 5B, the ceiling-mounted hooking receptacle 1 includes the terminal unit 2a adapted in use to be connected to the DC supply line (the feeder wire of the DC power source) Wdc from the installation site side, and the terminal unit 2b used for the power transmission wiring. The ceiling-mounted hooking receptacle 1 includes the hooking connection unit 3, the switch 4, the DLC communication unit 5, the power supply control unit 6, and an address registration unit 7. The hooking connection unit 3 is adapted in use to be detachably connected to the hooking cap 40 of the DC device 102. The aforementioned hooking connection unit 3 includes the hooking blade reception members 22 configured to hook the hooking blades 41 provided to the hooking cap 40. The switch 4 is provided to the power supply lines connecting the hooking connection unit 3 to the terminal units 2a and 2b. The aforementioned switch 4 can be selected from a relay contact, a semiconductor switch, and the like, for example. The DLC communication unit 5 is configured to establish the DLC communication with the external device either by superimposing the high frequency transmission signal on the DC voltage applied to the terminal unit 2a and 2b or separating the superimposed transmission signal from the DC voltage applied to the terminal unit 2a and 2b. The power supply unit 6 is configured to turn on and off the switch 4 on the basis of the control signal included in the transmission signal received from the external device.

The ceiling-mounted hooking receptacle 1 is provided with the address registration unit 7 to register own unique address. In the present embodiment, a DIP switch 7a of plural bits (e.g. six bits) shown in FIG. 60 is adopted as the address registration unit 7. As shown in FIGS. 6A and 6B, the DIP switch 7a is mounted on the lower surface of the housing 11. In a following explanation, the address registration unit 7 of the ceiling-mounted hooking receptacle 1A stores the unique address “1” as the own unique address, and the address registration unit 7 of the ceiling-mounted hooking receptacle 1B stores the unique address “2” as the own unique address.

The DC switch 50 is installed on a building surface such as a wall surface. As shown in FIG. 5B, the DC switch 50 includes the terminal unit 51a adapted in use to be connected to the DC supply line Wdc, and the terminal unit 52b used for the power transmission wiring. The DC switch 50 further includes the DLC communication unit 52, the manipulation unit 53, the on/off display unit 54, the control unit 55, and an address registration unit 56. The DLC communication unit 52 is configured to establish the DLC communication with the external device either by superimposing the high frequency transmission signal on DC voltage applied to the terminal unit 51a and 51b or separating the superimposed transmission signal from the DC voltage applied to the terminal unit 51a and 51b. The manipulation unit 53 serves to turn on and off the corresponding DC device 102. The on/off display unit 54 includes the light emitting diode (not shown). The on/off display unit 54 is configured to control the lighting state of the light emitting diode so as to display the on-state and off-state of the corresponding DC device 102. The light emitting diode is provided such that a user can see the lighting state of the light emitting diode from the front surface of the DC switch 50. The control unit 55 is configured to control each of units.

The DC switch 50 is provided with the address registration unit 56 to register own unique address and the unique address of the ceiling-mounted hooking receptacle 1 of the control target. In the present embodiment, the DC switch 50A has the address registration unit 56 registering the unique address “1” corresponding to the ceiling-mounted hooking receptacle 1A as its control target. The DC switch 50B has the address registration unit 56 registering the unique address “2” corresponding to the ceiling-mounted hooking receptacle 1B as its control target. The DC switch 50C has the address registration unit 56 registering two unique addresses “1” and “2” respectively corresponding to the ceiling-mounted hooking receptacles 1A and 1B as its control targets.

Next, an explanation is made to an on/off operation where the DC switch 50 turns on and off the DC device 102. In a condition where each of the lighting DC devices 102A and 102B is kept turned off, the control unit 55 of each of the DC switches 50A to 50C keeps on turning on the light emitting diode of the on/off display unit 54 in accordance with the monitoring signal received from the corresponding ceiling-mounted hooking receptacle 1A and/or 1B, thereby displaying the off-state of the DC device 102A and 102B as well as the location of each of the DC switches 50A to 50C.

Upon being manipulated to turn on the DC device 102 in this condition, the manipulation unit 53 of the DC switch 50A outputs the on-operation signal to the control unit 55. Upon receiving the on-operation signal, the control unit 55 controls the DLC communication unit 52 to send to the transmission signal (first transmission signal) to the corresponding ceiling-mounted hooking receptacle 1. The first transmission signal includes the unique address identical to that of the corresponding ceiling-mounted hooking receptacle 1A registered at the address registration unit 56, in addition to the control signal for turning on the DC switch 102.

The first transmission signal transmitted from the DC switch 50A is sent to the each of the ceiling-mounted hooking receptacles 1A and 1B via the DC supply line Wdc. When the DLC communication unit 5 of the ceiling-mounted hooking receptacle 1 receives the first transmission signal, the power supply control unit 6 checks the destination of the first transmission signal. In short, the power supply control unit 6 compares the unique address included in the received first transmission signal with the own unique address registered by the address registration unit 7. When the unique address included in the received first transmission signal is not identical to the own unique address registered by the address registration unit 7, the power supply control unit 6 discards the received first transmission signal. By contrast, when the unique address included in the received first transmission signal is identical to the own unique address registered at the address registration unit 7, the power supply control unit 6 controls the switch 4 in accordance with the control signal included in the received first transmission signal. In this instance, concerning the ceiling-mounted hooking receptacle 1A, the unique address included in the received first transmission signal is identical to the own unique address registered by the address registration unit 7. The received first transmission signal includes the control signal for turning on the DC switch 102. Therefore, the power supply control unit 6 of the ceiling-mounted hooking receptacle 1 turns on the switch 4.

Meanwhile, concerning the ceiling-mounted hooking receptacle 1B, the unique address included in the received first transmission signal is not identical to the own unique address registered by the address registration unit 7. Therefore, the DC switch 102B is kept turned off because no power is supplied to the DC switch 102B from the ceiling-mounted hooking receptacle 1B. In contrast, the power supply control unit 6 of the ceiling-mounted hooking receptacle 1A turns on the switch 4. Accordingly, because of that an enough electrical power is supplied to the DC switch 102A from the ceiling-mounted hooking receptacle 1A, and the DC device 102A is turned on. Further, the power supply control unit 6 controls the DLC communication unit 5 to send the transmission signal (second transmission signal) to the DC switch 50, at the same time that the power supply control unit 6 turns on the switch 4. Notably, the second transmission signal includes the monitoring signal indicative of the on-state of the switch 4 as well as the own unique address registered by the address registration unit 7.

When the DLC communication unit 52 of the DC switch 50 receives the second transmission signal, the control unit 55 checks the unique address of the received second transmission signal. In short, the control unit 55 compares the unique address included in the received second transmission signal with the unique address registered by the address registration unit 56. When the unique address included in the received second transmission signal is not identical to the unique address registered by the address registration unit 56, the control unit 55 discards the received second transmission signal. By contrast, when the unique address included in the received second transmission signal is identical to the unique address registered by the address registration unit 56, the control unit 55 controls the on/off display unit 54 in accordance with the monitoring signal included in the received second transmission signal. In this instance, concerning the DC switch 50A, the unique address included in the received second transmission signal is identical to that registered by the address registration unit 56. The received second transmission signal includes the monitoring signal indicating that the switch 4 is turned on. Therefore, the control unit 55 of the DC switch 50A turns off the light emitting diode of the on/off display unit 54. By contrast, in the aforementioned instance, concerning the DC switch 50B, since the unique address included in the received second transmission signal is not identical to that registered at the address registration unit 56, the second transmission signal is discarded. Therefore, the light emitting diode of the on/off display unit 54 of the DC switch 50B is kept turned on. Moreover, in the on/off display unit 54 of the DC switch 50C, the light emitting diode corresponding to the DC device 102A is turned off, and the light emitting diode corresponding to the DC device 102B is kept turned on, for example.

Thereafter, upon being manipulated to turn off the DC device 102, the manipulation unit 53 of the DC switch 50A outputs the off-operation signal to the control unit 55. Upon receiving the off-operation signal, the control unit 55 controls the DLC communication unit 52 to send to the transmission signal (third transmission signal) to the ceiling-mounted hooking receptacle 1. The third transmission signal includes the unique address identical to that of the corresponding ceiling-mounted hooking receptacle 1A registered by the address registration unit 56, in addition to the control signal for turning off the DC switch 102.

The third transmission signal transmitted from the DC switch 50A is sent to the each of the ceiling-mounted hooking receptacles 1A and 1B via the DC supply line Wdc. When the DLC communication unit 5 of the ceiling-mounted hooking receptacle 1 receives the third transmission signal, the power supply control unit 6 checks whether or not the third transmission signal is destined to itself. In short, the power supply control unit 6 compares the unique address included in the received third transmission signal with the own unique address registered by the address registration unit 7. When the unique address included in the received third transmission signal is not identical to the own unique address registered by the address registration unit 7, the power supply control unit 6 discards the received third transmission signal. By contrast, when the unique address included in the received third transmission signal is identical to the own unique address registered by the address registration unit 7, the power supply control unit 6 controls the switch 4 in accordance with the control signal included in the received third transmission signal. In this instance, concerning the ceiling-mounted hooking receptacle 1A, the unique address included in the received third transmission signal is identical to the own unique address registered by the address registration unit 7. The received third transmission signal includes the control signal for turning off the DC switch 102. Therefore, the power supply control unit 6 of the ceiling-mounted hooking receptacle 1A turns off the switch 4.

In the aforementioned instance, concerning the ceiling-mounted hooking receptacle 1B, since the unique address included in the received third transmission signal is not identical to the own unique address registered at the address registration unit 7, the third transmission signal is discarded. Therefore, the DC device 102B is kept turned off. Meanwhile, the power supply control unit 6 of the ceiling-mounted hooking receptacle 1A turns off the switch 4. Accordingly, the ceiling-mounted hooking receptacle 1A terminates supplying the enough electrical power to the DC switch 102A, thereby turning off the DC device 102A. Further, the power supply control unit 6 controls the DLC communication unit 5 to send the transmission signal (fourth transmission signal) to the DC switch 50, at the same time that the power supply control unit 6 turns off the switch 4. Notably, the fourth transmission signal includes the monitoring signal indicative of the off-state of the switch 4 as well as the own unique address registered by the address registration unit 7.

When the DLC communication unit 52 of the DC switch 50 receives the fourth transmission signal, the control unit 55 checks the unique address of the received fourth transmission signal. In short, the control unit 55 compares the unique address included in the received fourth transmission signal with the unique address registered at the address registration unit 56. When the unique address included in the received fourth transmission signal is not identical to the unique address registered at the address registration unit 56, the control unit 55 discards the received fourth transmission signal. By contrast, when the unique address included in the received fourth transmission signal is identical to the unique address registered at the address registration unit 56, the control unit 55 controls the on/off display unit 54 in accordance with the monitoring signal included in the received fourth transmission signal. In this instance, concerning the DC switch 50A, the unique address included in the received fourth transmission signal is identical to the unique address registered by the address registration unit 57. The received fourth transmission signal includes the monitoring signal indicating that the switch 4 is turned off. Therefore, the control unit 55 of the DC switch 50A turns on the light emitting diode of the on/off display unit 54. By contrast, in the aforementioned instance, concerning the DC switch 50B, since the unique address included in the received fourth transmission signal is not identical to the unique address registered by the address registration unit 57, the fourth transmission signal is discarded. Therefore, the light emitting diode of the on/off display unit 54 of the DC switch 50B is kept turned off. Moreover, in the on/off display unit 54 of the DC switch 50C, the light emitting diode corresponding to the DC device 102A is turned on, and the light emitting diode corresponding to the DC device 102B is kept turned on.

Further, the unique address “2” corresponding to the unique address of the ceiling-mounted hooking receptacle 1B is registered at the address registration unit 56 of the DC switch SOB. Therefore, when the manipulation 53 of the DC switch 50B is manipulated to turn on and off the DC device 102, the DC device 102B is turned on and off by means of processing similar to that described above. Moreover, both the unique address “1” corresponding to the unique address of the ceiling-mounted hooking receptacle 1A and the unique address “2” corresponding to the unique address of the ceiling-mounted hooking receptacle 1B are registered at the address registration unit 56 of the DC switch 50C. When the manipulation 53 of the DC switch 50B is manipulated to turn on and off the DC device 102, the DC switch 50C sends to the DC supply line Wdc in series the transmission signal including the unique address “1” corresponding to the unique address of the ceiling-mounted hooking receptacle 1A together with the control signal and the transmission signal including the unique address “2” corresponding to the unique address of the ceiling-mounted hooking receptacle 1B together with the control signal. As a result, the respective DC devices 102A and 102B are turned on and off by means of processing similar to that described above.

As described in the above, in the present embodiment, each of the ceiling-mounted hooking receptacles 1 includes the address registration unit 7 configured to register the own unique address. Moreover, each of the DC switches 50 includes the address registration unit 56 configured to register the unique address of the ceiling-mounted hooking receptacle 1 being the control target thereof. Thus, even if the plural ceiling-mounted hooking receptacles 1 are connected to the DC supply line Wdc, it is possible to distinguish each of the ceiling-mounted hooking receptacles 1. Therefore, it is possible to make and terminate supplying power to the respective DC devices 102 connected to each of the ceiling-mounted hooking receptacles 1. Further, the DIP switch 7a constructing the address registration unit 7 is mounted on the lower surface of the housing 11. Therefore, it is possible to register and change the unique address even after the ceiling-mounted hooking receptacle 1 is mounted on the ceiling.

### Third Embodiment

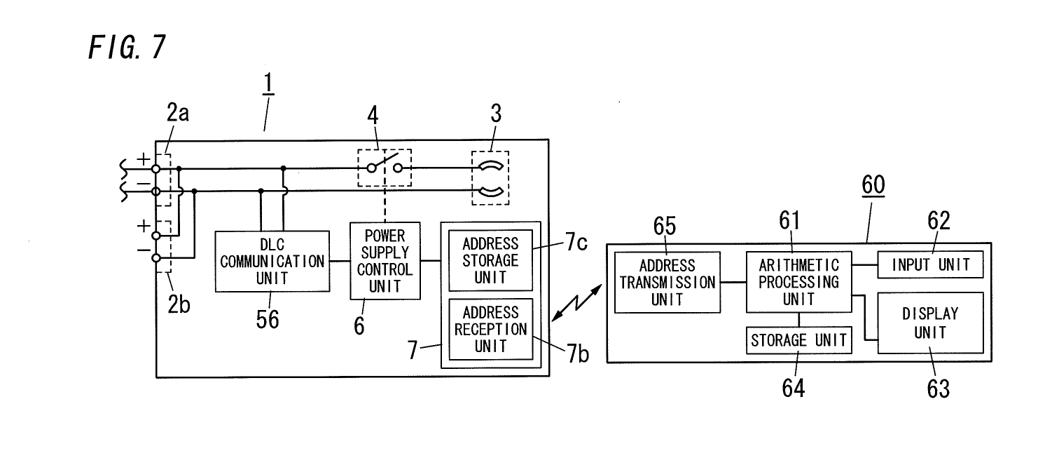

With reference to FIGS. 7 to 10, an explanation is made to the third embodiment of the present invention. In the present embodiment, the components of the ceiling-mounted hooking receptacle 1 with the exception of the address registration unit are the same as the aforementioned first and second embodiments. Therefore, the components common to the present embodiment and the other embodiment are designated by like reference numerals and dispensed with duplicate explanations.

In the ceiling-mounted hooking receptacle 1 explained in the second embodiment, the DIP switch 7a is used for registering the unique address. Meanwhile, in the present embodiment, the address registration device 60 is used for registering the unique address as shown in FIG. 7.

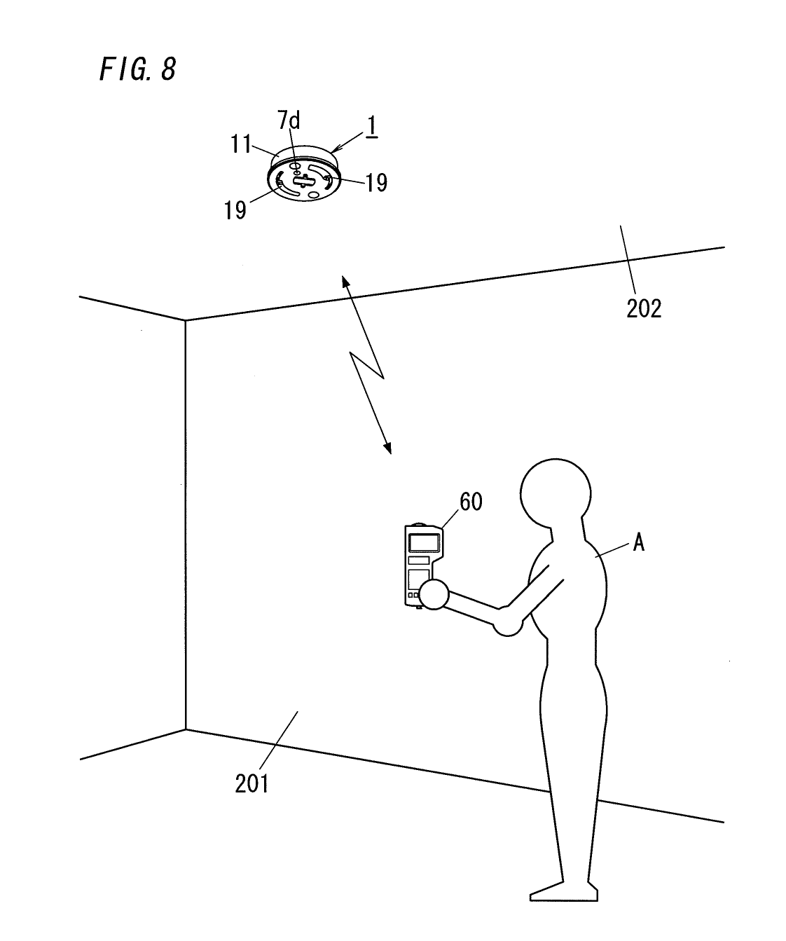

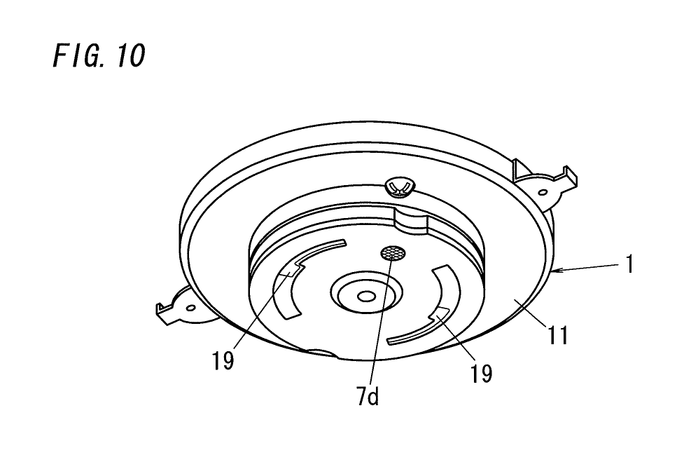

Consequently, the address registration unit 7 includes an address reception unit 7b and an address storage unit 7c. The address reception unit 7b is configured to receive a wireless signal transmitted by the address registration device 60. The address reception unit 7b is further configured to read out the unique address from the received wireless signal and store the same in the address storage unit 7c. As described in the above, the address reception unit 7b receives the address transmitted in the form of the wireless signal by the address registration unit 60. In the present embodiment, an infrared signal is adopted as the wireless signal. In response, the address reception unit 7b includes a light reception unit (not shown) configured to receive the infrared signal. The address reception unit 7b is housed in the housing such that the light reception unit is oriented downwardly. Moreover, as shown in FIG. 8, the housing 11 of the present embodiment is provided with a translucency window 7d. The translucency window 7d serves to allow the infrared signal to come into the light reception unit of the address reception unit 7b. Notably, FIG. 10 shows a perspective view illustrating the ceiling-mounted hooking receptacle 1 of the exposed type. Like the ceiling-mounted hooking receptacle 1 of the embedded type, the translucency window 7d is provided in the lower surface of the housing of the ceiling-mounted hooking receptacle 1 shown in FIG. 10.

The address registration device 60 is used for registering the unique address or the like in the ceiling-mounted hooking receptacle 1 of the present embodiment and other terminal devices used in a so-called remote control system (e.g. a monitoring terminal device for monitoring an input of switches and the like, and a control terminal device for turning on and off a load), As shown in FIG. 7, the address registration device 60 includes an arithmetic processing unit 61, an input unit 62, a display unit 63, a storage unit 64, and an address transmission unit 65. The arithmetic processing unit 61 is configured to integrally control a circuit component incorporated in the address registration device 60. The input unit 62 serves to make an input operation of inputting the unique address, a transmission operation of transmitting the unique address, and the like. The display unit 63 is, for example, a liquid crystal display. The display unit 63 is used for displaying the unique address input by the input unit 62 and the like. The storage unit 64 is used for registering the unique address. The address transmission unit 65 is configured to transmit the unique address by use of the wireless signal.

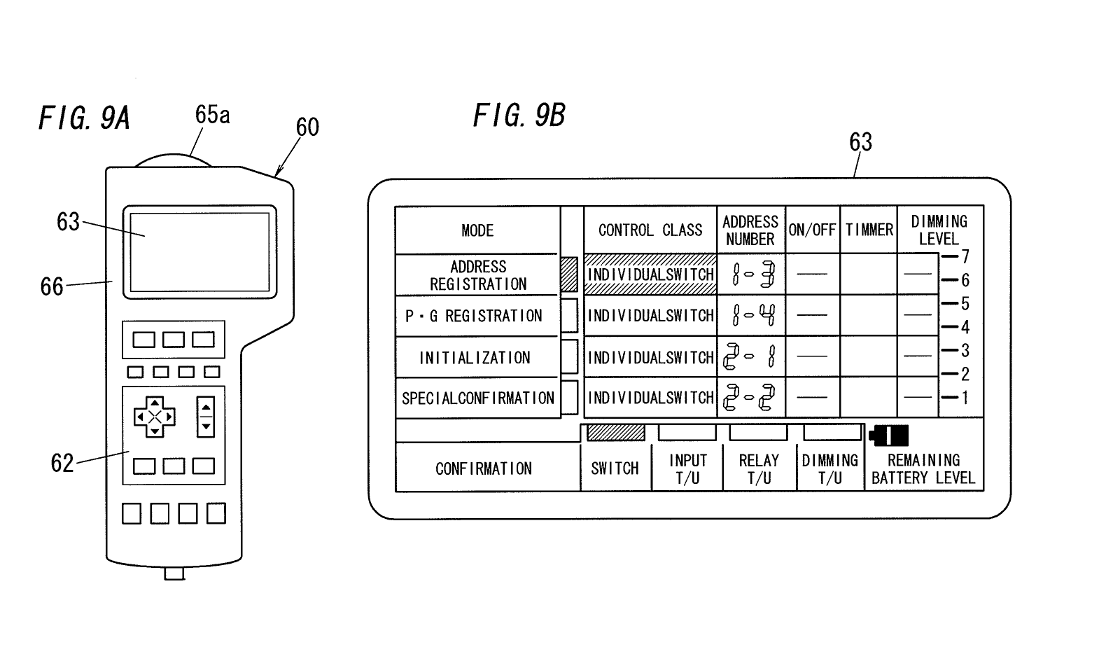

FIG. 9A shows an external view of the address registration unit 60. The address registration unit 60 includes a housing 66 formed to have dimensions permitting a user to grasp. A plurality of operation buttons constituting the input unit 62 is arranged on a lower portion of a front surface of the housing 66. The display unit 63 is arranged on an upper portion of the front surface of the housing 66. The address transmission unit 65 is arranged on an upper aspect of the housing 66.

FIG. 9B shows an instance of a registration screen displayed on the display unit 63 of the address registration device 60. In the address registration device 60, to manipulate the input unit 62 permits a user to input registration items such as the unique address of the ceiling-mounted hooking receptacle 1 of a registration target and the like. Thereafter, when the transmission operation is made, data such as registered unique address are sent from the address transmission unit 65.

As shown in FIG. 8, in a case of registering the unique address in the ceiling-mounted hooking receptacle 1 mounted on a ceiling 202 of a room 201, first a person A responsible for a construction makes the input operation of inputting the unique address by use of the address registration device 60. Thereafter, when the person A makes the transmission operation, the address transmission unit 65 of the address registration device 60 transmits the registered unique address in the form of the wireless signal (infrared signal). Meanwhile, the address reception unit 7b receives the wireless signal transmitted from the address registration device 60 via the translucency window 7d of the ceiling-mounted hooking receptacle 1. The address storage unit 7c stores the unique address received by the address reception unit 7b. Therefore, it is possible to make an address registration of the ceiling-mounted hooking receptacle 1 by use of the address registration device 60. In addition, in a case where the wireless signal is the infrared signal, the person A is required to manipulate the address registration device 60 below the ceiling-mounted hooking receptacle 1 of the registration target.

As described in the above, the present embodiment receives the unique address transmitted in the form of the wireless signal from the address registration device 60, and stores the same in the address storage unit 7c. Therefore, it is possible to make the address registration by use of the address registration device 60 from a remote location. Accordingly, it is possible to make easily the operation of registering the unique address of the ceiling-mounted hooking receptacle 1 mounted on the ceiling 202.

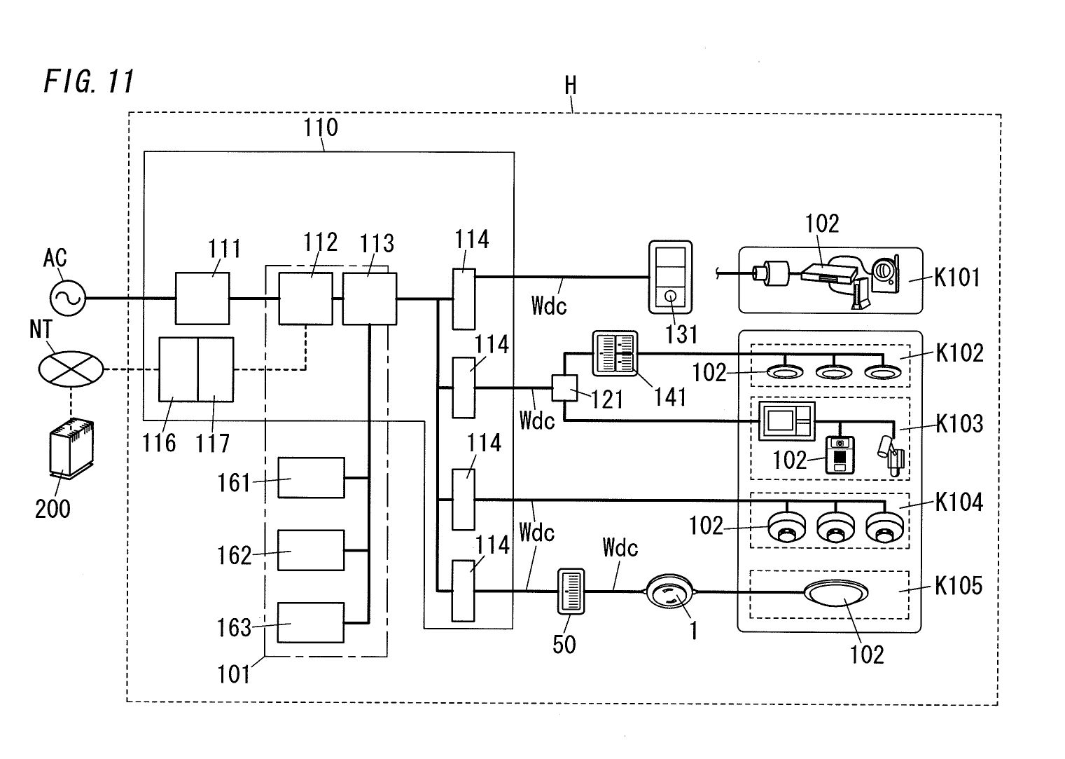

The above-mentioned ceiling-mounted hooking receptacle 1 of the respective embodiments can be used in a DC distribution system shown in FIG. 11, for example. In FIG. 11, a house H of a single-family dwelling is exemplified as a building where the DC distribution system is applied. However, the DC distribution system can be applied to a housing complex. There are a DC power supply unit 101 configured to output DC power and the DC device 102 placed in the house H. The DC device 102 is a load activated by DC power. DC power is supplied to the DC device 102 via a DC supply line Wdc connected to an output terminal of the DC power supply unit 101. There is a DC breaker 114 interposed between the DC power supply unit 101 and the DC device 102. The DC breaker 114 is configured to monitor current flowing through the DC supply line Wdc and to limit or terminate electrical power supply from the DC power supply unit 101 to the DC device 102 via the DC supply line Wdc upon detecting an abnormal state.

The DC supply line Wdc is adopted as a power line for DC power as well as a communication line. For example, it is possible to communicate between devices connected to the DC supply line Wdc by means of superimposing on a DC voltage a communication signal used for transmitting a data and made of a high-frequency carrier. This technique is similar to a power line communication technique where a communication signal is superimposed on an AC voltage applied to a power line for supplying an AC power.

The aforementioned DC supply line Wdc is connected to a home server 116 via the DC power supply unit 101. The home server 116 is a primary device for constructing a home communication network (hereinafter called “home network”). The home server 116 is configured to communicate with a subsystem constructed by the DC device 102 in the home network, for example.

In the instance shown in FIG. 11, an information system K101, lighting systems K102 and K105, an entrance system K103, and a home alarm system K104 are adopted as the subsystem. The each subsystem is an autonomous distributed system, and operates by itself. The subsystem is not limited to the aforementioned instance.

The DC breaker 114 is associated with the subsystem. In the instance shown in FIG. 11, each of the information system K101, a pair of the lighting system K102 and entrance system K103, the home alarm system K104, and the lighting system K105 is associated with one DC breaker 114. A connection box 121 is provided to associate one DC breaker 114 with a plurality of the subsystems. The connection box 121 is configured to divide a system of the DC supply line for each subsystem. In the instance shown in FIG. 11, the connection box 121 is interposed between the lighting system K102 and the entrance system K103.

The information system K101 includes the informational DC device 102 such as a personal computer, a wireless access point, a router, and an IP telephone transceiver. This DC device 102 is connected to a DC socket 131 preliminarily provided to the house H (provided at the time of constructing the house H) as a wall outlet or a floor outlet, for example.

Each of the lighting systems K102 and K105 includes the lighting DC device 102 such as a lighting fixture. In the instance shown in FIG. 11, the lighting system K102 includes the lighting fixture (DC device 102) preliminarily provided to the house H. It is possible to send a control instruction to the lighting fixture of the lighting system K102 by use of an infrared remote controller. Further, the control instruction can be sent by transmitting a communication signal from a switch 141 connected to the DC supply line Wdc. In short, the switch 114 has a function of communicating with the DC device 102. In addition, the control instruction can be sent by transmitting a communication signal from the home server 116 or other DC device 102 of the home network. The control instruction for the lighting fixture indicates such as turning on, turning off, dimming, and blinking. Meanwhile, the lighting system K105 includes the lighting fixture (DC device 102) connected to a ceiling-mounted hooking receptacle 1 preliminarily provided on a ceiling. It is noted that the lighting fixture is attached to the ceiling-mounted hooking receptacle 1 by a contractor at the time of constructing an interior of the house H or attached to the ceiling outlet 133 by a resident of the house H.

The entrance system K103 includes the DC device 102 configured to respond to a visitor and to monitor an intruder.

The home alarm system K104 includes the alarming DC device 102 such as a fire alarm.

Any DC device 102 can be connected to each of the aforementioned DC outlet 131 and ceiling-mounted hooking receptacle 1. Each of the DC outlet 131 and ceiling-mounted hooking receptacle 1 outputs DC power to the connected DC device 102. Therefore, the DC outlet 131 and ceiling-mounted hooking receptacle 1 are hereinafter collectively called the “DC outlet”, when a distinction between the DC outlet 131 and the ceiling-mounted hooking receptacle 1 is unnecessary.

A housing of the DC outlet has a connection slot (plug-in connection slot) for inserting a terminal of the DC device 102. A terminal receiving member configured to directly contact to the terminal which is inserted into the connection slot is housed in the case of the DC outlet. In short, the DC outlet with above mentioned configuration makes contact-type power supply. The DC device with a communication function is capable of transmitting a communication signal via the DC supply line Wdc. The communication function is provided to not only the DC device 102 but also DC outlet. It is noted that the terminal is directly attached to the DC device 102 or is attached to the DC device 102 via a connection wire.

The home server 116 is connected to not only the home network but also the wide area network NT constructing Internet. While the home server 116 is connected to the wide area network NT, a user can enjoy service provided by a center server (computer server) 200 connected to the wide area network.

The center server 200 provides service capable of monitoring or controlling a device (which is mainly the DC device 102, but which may be other apparatus having a communication function) connected to the home network via the wide area network NT, for example. The service enables monitoring or controlling a device connected to the home network by use of a communication terminal (not shown) having a browsing function such as a personal computer, an Internet TV, and a mobile telephone equipment.

The home server 116 has both a function of communicating with the center server 200 connected to the wide area network NT and a function of communicating with a device connected to the home network. The home server 116 further has a function of collecting identification information (assumed as “IP address” in this instance) concerning a device of the home network.

The home server 116 and center server 200 mediate a communication between a home device and a communication terminal in the wide area network NT. Therefore, it is possible to monitor or control the home device by use of the communication terminal.

When a user attempts to monitor or control the home device by use of the communication terminal, the user controls the communication terminal so as to store a monitoring request or a control request in the center server 200. The device placed in the house establishes periodically one-way polling communication, thereby receiving the monitoring request or control request from the communication terminal. According to the aforementioned operation, it is possible to monitor or control the device placed in the house by use of the communication terminal.

When an event (such as fire detection) of which the home device should notify the communication terminal occurs, the home device notifies the center server 200 of occurrence of the event. When the center server 200 is notified of the occurrence of the event by the home device, the center server 200 notifies the communication terminal of the occurrence of the event by use of an e-mail.

A function of communicating with the home network of the home server 116 includes an important function of detecting and managing a device constructing the home network. By means of utilizing UPnP (Universal Plug and Play), the home server 116 automatically detects a device connected to the home network. The home server 116 further includes a display device 117 having a browsing function, and controls the display device 117 to display a list of the detected device. The display device 117 includes a touch panel or another user interface unit. Therefore, it is possible to select a desired one from options displayed on a screen of the display device 117. Accordingly, a user (a contractor or a resident) of the home server 116 can monitor and control the device through the screen of the display device 117. The display device 117 may be separated from the home server 116.

The home server 116 manages information with relation to connection of a device. For example, the home server 116 stores a type or a function and an address of the device connected to the home network. Therefore, it is possible to make a linked operation between devices of the home network. As described in the above, the information with relation to connection of a device is automatically detected. In order to make the linked operation between the devices, it is sufficient that an association between devices is automatically made by an attribution of a device. An information terminal such as a personal computer may be connected to the home server 116. In this case, the association between devices can be made by use of a browsing function of the information terminal.

Each of the devices holds a relation with regard to the linked operations between the devices. Therefore, the devices can make the linked operation without requiring to access to the home server 116. After establishing an association with regard to the linked operation of respective devices, a lighting fixture, which is one of the devices, is caused to turn on and off by manipulation of a switch, which is another of the devices, for example. Although the association with regard to the linked operation is made for the devices belonging to the same subsystem, the association with regard to the linked operation may be made for the devices belonging to the different subsystems.

The DC supply unit 101 is configured to basically generate DC power from AC power supplied from an AC power source (for example a commercial power source located outside) AC. In the instance shown in FIG. 11, the AC power source AC is connected to an AC/DC converter 112 including a switching regulator via a main breaker 111. The main breaker 111 is embedded in a distribution board 110. DC power output from the AC/DC converter 112 is supplied to each DC breaker 114 via a cooperation control unit 113.

The DC supply unit 101 is provided with a secondary cell 162 in view of a period (blackout period of the commercial power source) in which the DC supply unit 101 fails to receive electrical power from the AC power source AC. A solar cell 161 and fuel cell 163 configured to generate DC power can be used together with the secondary cell 162. The solar cell 161, secondary cell 162, and fuel cell 163 respectively are a dispersed power source, in view of a main power source including the AC/DC converter 112. In the instance shown in FIG. 11, the solar cell 161, secondary cell 162, and fuel cell 163 respectively include a circuit unit configured to control its output voltage. The solar cell 161 further includes not only a circuit unit of controlling electrical discharge but also a circuit unit of controlling electrical charge.

Although the solar cell 161 and fuel cell 163 of the dispersed power sources are dispensable, the secondary cell 162 is preferred to be provided. The secondary cell 162 is charged by the main power source or the other dispersed power source at the right time. The secondary cell 162 is discharged during a period in which the DC supply unit 101 fails to receive electrical power from the AC power source AC. In addition, the secondary cell 162 is discharged at the right time as necessary. The cooperation control unit 113 is configured to control discharge and charge of the secondary cell 162 and to make cooperation between the main power source and the dispersed power source. In short, the cooperation control unit 113 functions as a DC power control unit configured to control distributing to the DC device 102 electrical power from the main power source and dispersed power source constituting the DC supply unit 101. It is noted that DC power from the solar cell 161, secondary cell 162, and fuel cell 163 may be input to the AC/DC converter 112 by converting into AC power.

A drive voltage of the DC device 102 is selected from different voltages respectively suitable to individual devices of different voltage requirements. For this purpose, the cooperation control unit 113 is preferred to include a DC/DC converter configured to convert DC voltage from the main power source and dispersed power source into a desired voltage. Normally, a fixed voltage is applied to one subsystem (or the DC device 102 connected to one particular DC breaker 114). However, different voltages may be selectively applied to one subsystem by use of three or more lines. Use of two wired DC supply line Wdc can vary the voltage applied between wires with time. The DC/DC converter can be placed at plural points in a similar fashion as the DC breakers.

In the instance shown in FIG. 11, only one AC/DC converter 112 is provided. However, a plurality of AC/DC converters 112 may be connected in parallel to each other. When the plurality of the AC/DC converters 112 is provided, it is preferred to vary the number of the AC/DC converters 112 being activated in accordance with a magnitude of the load.

The aforementioned AC/DC converter 112, cooperation control unit 113, DC breaker 114, solar cell 161, secondary cell 162, and fuel cell 163 respectively are provided with a communication function. Therefore, the linked operation can be performed in response to status of each of the main power source, dispersed power source, and loads including the DC device 102. Like a communication signal used for the DC device 102, a communication signal used by the communication function is transmitted by being superimposed on DC voltage.

In the instance shown in FIG. 11, in order to convert AC power output from the main breaker 111 into DC power, the AC/DC converter 112 is placed in the distribution panel 110. However, the AC/DC converter 112 is not necessarily placed in the distribution panel 110. For example, branch breakers (not shown) may be connected to an output side of the main breaker 111 in the distribution panel 110 such that a plurality of systems is branched off from an AC supply line, and an AC/DC converter may be provided to an AC supply line of each of the systems. That is, each system may be provided with an apparatus configured to convert AC power into DC power.

In this instance, it is possible to provide the DC supply unit 101 to each unit such as a floor or room of the house H. Accordingly, it is possible to manage the DC supply unit 101 for each system. In addition, it is possible to shorten a distance between the DC supply unit 101 and the DC device 102 configured to utilize DC power. Therefore, it is possible to reduce power loss caused by a voltage drop which occurs in the DC supply line Wdc. Alternatively, the main breaker 111 and branch breaker may be housed in the distribution panel 110, and the AC/DC converter 112, cooperative control unit 113, DC breaker 114, and home server 116 may be placed in another panel different from the distribution panel 110.

1. A ceiling-mounted hooking receptacle comprising:
a housing adapted in use to be mounted on an installation site, and said housing being formed with a plurality of hooking blade insertion slots having an arc shape in its surface different from its installation site side surface;
a plurality of terminals housed in said housing, and each of said terminals being adapted in use to be connected to a feeder wire of a DC power source inserted into said housing from the installation site side of said housing; and
a plurality of hooking blade reception members housed in said housing so as to respectively correspond to the plurality of said hooking blade insertion slots, and the plurality of said hooking blade reception members being respectively electrically connected to the plurality of said terminals,
wherein said hooking blade reception members is configured to hook said hooking blade when a hooking blade of a hooking cap has been inserted into said housing via a first end portion of said hooking blade insertion slot and subsequently has been moved to a second end portion of said hooking blade insertion slot, and
wherein said ceiling-mounted hooking receptacle comprises a contact provided to a power supply line between the plurality of said terminals and the plurality of said hooking blade reception members,
said housing being configured to house a communication unit and a power supply control unit,
said communication unit being configured to communicate with an external device by use of a transmission signal superimposed on DC voltage applied to said terminal, and
said power supply control unit being configured to turn on or off said contact on the basis of a control signal included in the transmission signal received by said communication unit.

2. A ceiling-mounted hooking receptacle as set forth in claim 1, further comprising:
an address registration unit configured to register a unique address,
wherein said power supply control unit is configured to, when a unique address included in the transmission signal received by said communication unit is identical to the unique address registered by said address registration unit, turn on and off said contact on the basis of the control signal included in the received transmission signal.

3. A ceiling-mounted hooking receptacle as set forth in claim 2, wherein
said address registration unit includes an address reception unit configured to receive a unique address transmitted in the form of a wireless signal by an external address registration device and an address storage unit configured to store the unique address received by said address reception unit as the unique address.
